(19) United States
(12) Patent Application Publication
(10) Pub. No.: US 2026/0337392 A1
(43) Pub. Date: Oct. 29, 2026

(54) POLYOLEFINS COMPOSITIONS OBTAINED FROM RECYCLED POLYOLEFINS

(71) Applicant: Basell Poliolefine Italia S.r.l., Milano (IT)

(72) Inventors: Stefano Spataro, Ferrara (IT); Davide Tartari, Ferrara (IT); Cristina Cova, Ferrara (IT); Claudio Cavalieri, Ferrara (IT)

(73) Assignee: Basell Poliolefine Italia S.r.l., Milano (IT)

(21) Appl. No.: 19/110,766

(22) PCT Filed: Aug. 21, 2023
(86) PCT No.: PCT/EP2023/072891

§ 371 Date: Mar. 11, 2025

(30) Foreign Application Priority Data
Sep. 14, 2022 (EP) 22195661.8

(51) Int. Cl. C08L 23/12; H01M 50/121; H01M 50/14; H01M 50/227; H01M 50/242; H01M 50/249

(52) U.S. Cl. CPC C08L 23/12; H01M 50/121; H01M 50/14; H01M 50/227; H01M 50/242; H01M 50/249; C08L 2203/20; C08L 2205/025; C08L 2205/035; C08L 2207/20; H01M 2220/20

(57) ABSTRACT

A polypropylene composition made from or containing:
(a) from 45.7 wt % to 69.7 wt % of a crystalline propylene polymer
(b) from 5.3 wt % to 29.3 wt % of an elastomeric copolymer of ethylene and propylene;
(c) from 3.0 wt % to 27.0 wt % of recycled polyethylene (r-PE); and
d) from 1.0 wt % to 15.0 wt % of a crystalline propylene homopolymer;
wherein the percentages of (a), (b), (c) and (d) being referred to the sum of (a), (b), (c) and (d).

### FIELD OF THE INVENTION

In general, the present disclosure relates to the field of chemistry. More specifically, the present disclosure relates to polymer chemistry. In particular, the present disclosure relates to polyolefin compositions made from or containing recycled polyethylene.

### BACKGROUND OF THE INVENTION

In some instances, polyolefin compositions for use in injection-molded articles have stiffness, impact resistance and stress-whitening resistance.

In some instances, polyolefin compositions raise concerns of sustainability because production is based on non-renewable sources.

In some instances and to mitigate the sustainability issues, there have been attempts to use recycled polyolefins such as polypropylene or polyethylene in multicomponent polyolefin compositions.

Such efforts to address issues of sustainability through polyolefin recycling have shown limited success because of difficulty separating polypropylene (PP) from polyethylene (PE) quantitatively and vice-versa. Thus, although named recycled PE (rPE) or recycled PP (rPP), the commercially available products from post-consumer waste (PCW) sources are mixtures of PP and PE.

In some instances, the presence of additives and minor components in the recycled materials limits usefulness in various applications, leads to deteriorated mechanical and optical properties, and limits compatibility between the main polymer phases during remolding. In some instances, articles made from or containing r-PP or r-PE are perceived as having lower reliability.

In some instances, the recycled materials have limited use in applications requiring a high-performance level and are directed to low-cost and non-demanding applications.

### SUMMARY OF THE INVENTION

In a general embodiment, the present disclosure provides a polypropylene composition made from or containing:
(a) from 45.7 wt % to 69.7 wt %, alternatively from 47.7 wt % to 67.7 wt %, alternatively from 50.7 wt % to 64.7 wt %, of a crystalline propylene polymer, having an amount of isotactic pentads (mmmm), measured by 13C-MNR on the fraction insoluble in xylene at 25 °C, higher than 97.0 molar % and a polydispersity index ranging from 3 to 15;
(b) from 5.3 wt % to 29.3 wt %, alternatively from 7.3 wt % to 27.3 wt %, alternatively from 10.3 wt % to 24.3 wt %, of an elastomeric copolymer of ethylene and propylene, having an amount of recurring units deriving from ethylene, measured by 13C-NMR ranging from 30.0 wt % to 70.0 wt %, alternatively from 35.0 wt % to 60.0 wt %; alternatively from 40.0 wt % to 53.0 wt %, wherein, in the blend of components a) and b),
   i) the polymer fraction soluble in xylene at 25 °C of components a)+b) ranging from 10.0 wt % to 32.5 wt %; alternatively ranging from 14.0 wt % to 28.2 wt %; alternatively ranging from 17.0 wt % to 25.1 wt %;
   ii) the polymer fraction soluble in xylene at 25 °C of components a)+b), having an intrinsic viscosity value, measured in tetrahydronaphthalene at 135 °C, ranging from 1.5 dl/g to 2.8 dl/g; alternatively ranging from 1.7 dl/g to 2.7 dl/g; alternatively ranging from 1.8 dl/g to 2.6 dl/g;
   iii) the ethylene derived units content, measured by 13C-NMR in the fraction soluble in xylene at 25 °C, of components a)+b ranging from 24.4 wt % to 43.5 wt %; alternatively ranging from 31.0 wt % to 42.0 wt %, alternatively ranging from 29.0 wt % to 40.0 wt %, alternatively ranging from 32.0 wt % to 39.0 wt %;
   iv) the melting point, measured by DSC, of components a)+b ranging from 148.0 °C to 168.0 °C; alternatively ranging from 154.0 °C to 167.0 °C; alternatively ranging from 162.0 °C to 166.0 °C; and
   v) the melt flow rate (ISO 1133-1 230 °C/2.16 kg) of components a)+b ranging from 10.0 to 30.0 g/10 min; alternatively ranging from 13.0 to 25.0 g/10 min, alternatively ranging from 16.0 to 22.0 g/10 min;
(c) from 3.0 wt % to 27.0 wt %, alternatively from 5.0 wt % to 25.0 wt %, alternatively from 7.0 wt % to 23.0 wt %, of a recycled polyethylene (r-PE), having a melt flow rate (ISO 1133-1 190 °C/2.16 Kg) from 0.1 to 10.0 g/10 min and containing an amount of polypropylene inclusions ranging from 1 wt % to 15 wt %, based upon the total r-PE component, and
d) from 1.0 wt % to 15.0 wt %, alternatively from 5.0 wt % to 13.0 wt %, alternatively from 7.0 wt % to 12.0 wt %, of a crystalline propylene homopolymer, having a melt flow rate (ISO 1133-1 230 °C/2.16 kg) ranging from 0.3 to 10.0 g/10 min; alternatively ranging from 1.0 to 5.0 g/10 min, alternatively ranging from 1.5 to 3.0 g/10 min, and a density (ISO 1183-1) ranging from 0.850 g/cm³ to 0.950 g/cm³; alternatively from 0.870 g/cm³ to 0.930 g/cm³; alternatively from 0.890 g/cm³ to 0.910 g/cm³;
wherein the whole composition having a value of melt flow rate (ISO 1133-1 230 °C/2.16 kg) ranging from 3.0 g/10 min to 21.0 g/10 min; alternatively from 4.3 g/10 min to 18.0 g/10 min, alternatively from 9.0 g/10 min to 16.0 g/10 min; and the percentages of (a), (b), (c) and (d) being referred to the sum of (a), (b), (c) and (d).

### DETAILED DESCRIPTION OF THE INVENTION

As used herein, the term “copolymer” refers to both polymers with two different recurring units and polymers with more than two different recurring units, such as terpolymers, in the chain. As used herein, the term “ambient temperature” refers to a temperature of 25 °C (room temperature).

As used herein, the term “crystalline propylene polymer” refers to a propylene polymer having an amount of isotactic pentads (mmmm), measured by 13C-NMR on the fraction insoluble in xylene at 25 °C, higher than 70 molar %. As used herein, the term “elastomeric” polymer refers to a polymer having solubility in xylene at ambient temperature higher than 50 wt %.

The features of the copolymers (a)-(d) are not inextricably linked to each other. In some embodiments, a level of a feature does not involve the same level of the remaining features.

In some embodiments, crystalline propylene polymer (a) is selected from a propylene homopolymer and a copolymer of propylene containing at most 3.0 wt % of ethylene or a C4-C10α-olefin or combination thereof. In some embodiments, crystalline propylene polymer (a) is a propylene homopolymer.

In some embodiments, the polydispersity Index ranges from 3 to 10.

In some embodiments, the r-PE (c) is crystalline or semicrystalline high density PE (r-HDPE). In some embodiments, r-HDPE is selected from commercial PCW (Post Consumer Waste). In some embodiments, commercial PCW is from municipalities. In some embodiments, r-PE (c) has a density (ISO 1183-1) ranging from 0.940 g/cm³ to 0.965 g/cm³ and a melt flow rate (ISO 1133-1 190 °C/2.16 Kg ISO 1133-1) ranging from 0.1 to 1.0 g/10 min.

In some embodiments and prior to use, the plastic mixture containing rHDPE undergoes recycling processes including collection, shredding, sorting and washing. In some embodiments, the sorted rHDPE contains HDPE and minor amounts of other polymeric or inorganic components. In some embodiments, the r-PE contains inclusion of polypropylene in an amount from 1.0 wt % to 15 wt %, alternatively from 5 wt % up to 10 wt %, based on the total r-PE component.

In some embodiments, the r-PE includes a crystalline polyethylene fraction wherein the amount of recurring units derived from propylene in the polyethylene chains is lower than 11% wt, alternatively absent. In some embodiments, r-PE is an ethylene homopolymer containing the inclusions. In some embodiments, r-PE has a melt flow rate (ISO 1133-1 190 °C/2.16 Kg ISO 1133-1) from 0.1 to 1.0 g/10 min, alternatively from 0.1 to 0.5 g/10 min.

In some embodiments, the r-PE is commercially available. In some embodiments, the r-PE is commercially available under the tradename Hostalen QCP5603 in ivory or grey versions, from LyondellBaseell.

In some embodiments, the whole polypropylene composition has a tensile modulus value of at least 1000 MPa, alternatively from 1050 to 1700 MPa, alternatively from 1100 MPa, to 1600 MPa.

In some embodiments, the whole polypropylene composition has a Charpy impact resistance at 23 °C higher than 10.0 KJ/m², alternatively ranging from 10.5 to 18.0 KJ/m², alternatively ranging from 11.0 to 17.0 KJ/m². In some embodiments, the whole polypropylene composition has a Charpy impact resistance at 0 °C of more than 6.0 KJ/m², alternatively ranging from 6.5 to 12.0 KJ/m², alternatively ranging from 7.0 to 10.0 kJ/m². In some embodiments, the whole polypropylene composition has a Charpy impact resistance at −20 °C of at least 4.0 KJ/m²; alternatively ranging from 4.5 to 10.0 KJ/m²

In some embodiments, component d) is a propylene homopolymer is commercially available under the tradename Adstif HA622H from LyondellBasell.

In some embodiments, the whole polypropylene composition is obtained by mechanical blending components (a)-(d).

In some embodiments, components (c) and (d) are mechanically blended with a preformed heterophasic composition made from or containing components (a) and (b) prepared together by a sequential copolymerization process.

In some embodiments, the process includes the steps of (1) polymerizing propylene alone or in mixture with a low amount of ethylene in a first stage and (2) polymerizing propylene with a higher amount of ethylene in a second stage, wherein both stages are conducted in the presence of a catalyst made from or containing the product of the reaction between:
i) a solid catalyst component made from or containing Ti, Mg, Cl, and an internal electron donor compound;
ii) an alkylaluminum compound; and
iii) an external electron-donor compound having the formula:
   (R⁷)ₐ(R⁸)_{b}Si(OR⁹)_{c}, where a and b are integers from 0 to 2, c is an integer from 1 to 4 and the sum (a+b+c) is 4; R⁷, R⁸, and R⁹ are alkyl, cycloalkyl or aryl radicals with 1-18 carbon atoms optionally containing heteroatoms.

In some embodiments, the internal donor is selected from the esters of mono or dicarboxylic organic acids such as benzoates, malonates, phthalates and certain succinates. In some embodiments, the internal donors are as described in U.S. Pat. No. 4,522,930A, European Patent No. 045977A2 and Patent Cooperation Treaty Publication Nos. WO 00/63261 and WO 01/57099. In some embodiments, the internal donor is selected from the group consisting of phthalic acid esters and succinate acids esters. In some embodiments, the internal donor is an alkylphthalate. In some embodiments, the alkylphthalate is selected from the group consisting of diisobutyl phthalate, dioctyl phthalate, diphenyl phthalate, and benzyl-butyl phthalate.

In some embodiments, the particles of solid component (i) have substantially spherical morphology and an average diameter ranging between 5 and 150 μm, alternatively from 20 to 100 μm, alternatively from 30 to 90 μm. As used herein, the term “substantially spherical morphology” refers to particles having the ratio between the greater axis and the smaller axis equal to or lower than 1.5, alternatively lower than 1.3.

In some embodiments, the amount of Mg ranges from 8 to 30 wt %, alternatively from 10 to 25 wt. %.

In some embodiments, the amount of Ti ranges from 0.5 to 7 wt %, alternatively from 0.7 to 5 wt. %.

In some embodiments, the solid catalyst component (i) is prepared by reacting a titanium compound of formula Ti(OR)q-yXy, where q is the valence of titanium and y is a number between 1 and q, with a magnesium chloride deriving from an adduct of formula MgCl2·pROH, where p is a number between 0.1 and 6, alternatively from 2 to 3.5, and R is a hydrocarbon radical having 1-18 carbon atoms. In some embodiments, the titanium compound is TiCl₄. In some embodiments, the adduct is prepared in spherical form by mixing alcohol and magnesium chloride, operating under stirring conditions at the melting temperature of the adduct (100-130 °C). Then, the adduct is mixed with an inert hydrocarbon immiscible with the adduct, thereby creating an emulsion which is quickly quenched causing the solidification of the adduct in form of spherical particles. In some embodiments, the procedure for the preparation of the spherical adducts is as disclosed in U.S. Pat. Nos. 4,399,054 and 4,469,648. In some embodiments, the adduct is directly reacted with Ti compound or subjected to thermal controlled dealcoholation (80-130 °C), thereby obtaining an adduct wherein the number of moles of alcohol is lower than 3, alternatively between 0.1 and 2.5. In some embodiments, the reaction with the Ti compound is carried out by suspending the adduct (dealcoholated or as such) in cold TiCl₄; the mixture is heated up to 80-130 °C and maintained at this temperature for 0.5-2 hours. In some embodiments, the treatment with TiCl₄ is carried out one or more times. In some embodiments, the electron donor compound is added during the treatment with TiCl₄.

In some embodiments, the alkyl-Al compound (ii) is selected from the group consisting of trialkyl aluminum compounds, alkylaluminum halides, alkylaluminum hydrides, and alkylaluminum sesquichlorides. In some embodiments, the alkyl-Al compound (ii) is a trialkyl aluminum compound selected from the group consisting of triethylaluminum, triisobutylaluminum, tri-n-butylaluminum, tri-n-hexylaluminum, and tri-n-octylaluminum. In some embodiments, the alkyl-Al compound (ii) is an alkylaluminum sesquichloride selected from the group consisting of AlEt2Cl and A12Et3Cl3. In some embodiments, the alkyl-Al compound (ii) is a mixture including trialkylaluminums. In some embodiments, the Al/Ti ratio is higher than 1, alternatively ranges between 50 and 2000.

In some embodiments, the silicon compounds (iii) are wherein a is 1, b is 1, c is 2, at least one of R7 and R8 is selected from branched alkyl, cycloalkyl or aryl groups with 3-10 carbon atoms, optionally containing heteroatoms, and R9 is a C1-C10 alkyl group. In some embodiments, R9 is methyl. In some embodiments, the silicon compounds are selected from the group consisting of methylcyclohexyldimethoxysilane (C donor), diphenyldimethoxysilane, methyl-t-butyldimethoxysilane, dicyclopentyldimethoxysilane (D donor), diisopropyldimethoxysilane, (2-ethylpiperidinyl) t-butyldimethoxysilane, (2-ethylpiperidinyl)thexyldimethoxysilane, (3,3,3-trifluoro-n-propyl) (2-ethylpiperidinyl)dimethoxysilane, and methyl (3,3,3-trifluoro-n-propyl)dimethoxysilane. In some embodiments, the silicon compounds are wherein a is 0, c is 3, R8 is a branched alkyl or cycloalkyl group, optionally containing heteroatoms, and R9 is methyl. In some embodiments, the silicon compounds are selected from the group consisting of cyclohexyltrimethoxysilane, t-butyltrimethoxysilane and thexyltrimethoxysilane.

In some embodiments, the amount of external electron donor compound (iii) provides a molar ratio between the alkylaluminum compound and the external electron donor compound (iii) of from 0.1 to 200, alternatively from 1 to 100 and, alternatively from 3 to 50.

In some embodiments, the polymerization process is carried out in gas-phase, operating in one or more fluidized or mechanically agitated bed reactors, slurry polymerization using as diluent an inert hydrocarbon solvent, or bulk polymerization using the liquid monomer as a reaction medium. In some embodiments, the liquid monomer is propylene.

In some embodiments, the heterophasic composition is obtained with a sequential polymerization process in two or more stages, wherein component (a) is obtained in the first stage and then component (b) is obtained in the second stage in the presence of component (a). In some embodiments, each stage is in gas-phase, operating in one or more fluidized or mechanically agitated bed reactors, or bulk polymerization using the liquid monomer as a reaction medium. In some embodiments, the liquid monomer is propylene. In some embodiments, hybrid processes are used, wherein a first stage is carried out in liquid monomer and a second stage is carried out in gas-phase. In some embodiments, component (a) is prepared in the first stage. In some embodiments, component (b) is prepared in the second stage.

In some embodiments, and as described in European Patent No. 782587, component (a) is prepared in a gas-phase reactor, having a first and a second interconnected polymerization zone to which propylene and optionally ethylene are fed in the presence of a catalyst system and from which the polymer produced is discharged. The growing polymer particles flow through the first of the polymerization zones (riser) under fast fluidization conditions, leave the first polymerization zone, enter the second of the polymerization zones (downcomer) through which the polymer particles flow in a densified form under the action of gravity, leave the second polymerization zone, and are reintroduced into the first polymerization zone, thereby establishing a circulation of polymer between the two polymerization zones. In some embodiments, the conditions of fast fluidization in the first polymerization zone are established by feeding the monomers gas mixture below the point of reintroduction of the growing polymer into the first polymerization zone. In some embodiments, the velocity of the transport gas into the first polymerization zone is higher than the transport velocity under the operating conditions and between 2 and 15 m/s. In the second polymerization zone, where the polymer flows in densified form under the action of gravity, high values of density of the solid are reached which approach the bulk density of the polymer. In some embodiments, a positive gain in pressure is thereby obtained along the direction of flow, permitting reintroduction of the polymer into the first reaction zone without the help of mechanical devices. In this way, a “loop” circulation is set up, which is defined by the balance of pressures between the two polymerization zones and by the head loss introduced into the system. In some embodiments, one or more inert gases, such as nitrogen or an aliphatic hydrocarbon, are maintained in the polymerization zones, in quantities such that the sum of the partial pressures of the inert gases is between 5 and 80% of the total pressure of the gases. In some embodiments, the various catalyst components are fed to the first polymerization zone, at any point of the first polymerization zone. In some embodiments, the various catalyst components are fed at any point of the second polymerization zone. In some embodiments, molecular weight regulators are used to regulate the molecular weight of the growing polymer. In some embodiments, the molecular weight regulator is hydrogen. In some embodiments, a bimodal set-up is achieved with the use of a barrier stream as described European Patent Application No. EP-A-1012195, thereby separating the polymerization environment of riser and downcomer.

In some embodiments, the polymerization is carried out at temperature of from 20 to 120 °C, alternatively of from 40 to 80 °C In some embodiments, the polymerization is carried out in gas-phase and the operating pressure is between 0.5 and 5 MPa, alternatively between 1 and 4 MPa. In some embodiments, the polymerization is carried out in bulk polymerization and the operating pressure ranges between 1 and 8 MPa, alternatively between 1.5 and 5 MPa. In some embodiments, hydrogen is used as a molecular weight regulator.

In some embodiments, the final heterophasic composition made from or containing (a)+ (b) is subject to a chemical treatment with organic peroxides, thereby lowering the average molecular weight and increasing the melt flow index for a specific application.

In some embodiments, the final composition made from or containing the components (a)-(d) and optionally, additives, fillers and pigments. In some embodiments, the additives are selected from nucleating agents and extension oils. In some embodiments, the fillers are mineral fillers. In some embodiments, the pigments are selected from the group consisting of organic and inorganic pigments. In some embodiments, the fillers are inorganic fillers selected from the group consisting of talc, calcium carbonate and mineral fillers.

In some embodiments, the nucleating agents are added in quantities ranging from 0.05 to 2% by weight, alternatively from 0.1 to 1% by weight, with respect to the total weight.

In some embodiments, the polypropylene composition is used for obtaining injection molded articles of manufacture. In some embodiments, the polypropylene compositions are for the preparation of automotive battery cases.

The following examples are given to illustrate, but not limit the present disclosure.

### EXAMPLES

### Characterizations

### Xylene-Soluble (XS) Fraction at 25 °C

2.5 g of polymer and 250 ml of xylene were introduced into a glass flask equipped with a refrigerator and a magnetic stirrer. The temperature was raised in 30 minutes up to the boiling point of the solvent. The resulting clear solution was then kept under reflux and stirred for 30 minutes. The closed flask was then kept for 30 minutes in a bath of ice and water, then in a thermostatic water bath at 25 °C for 30 minutes. The resulting solid was filtered on quick filtering paper. 100 ml of the filtered liquid were poured into a pre-weighed aluminum container, which was heated on a heating plate under nitrogen flow, thereby removing the solvent by evaporation. The container was then kept in an oven at 80 °C under vacuum until a constant weight was obtained. The weight percentage of polymer soluble in xylene at room temperature was then calculated.

The content of the xylene-soluble fraction is expressed as a percentage of the original 2.5 grams and then, by the difference (complementary to 100%), the xylene insoluble percentage (%).

### Melt Flow Rate (MFR)

Measured according to ISO 1133-1 at 230 °C with a load of 2.16 kg, unless otherwise specified.

### Density

Measured according to ISO 1183-1

### Intrinsic Viscosity (IV)

The sample was dissolved in tetrahydronaphthalene at 135 °C and then poured into a capillary viscometer. The viscometer tube (Ubbelohde type) was surrounded by a cylindrical glass jacket; this setup allowed for temperature control with a circulating thermostatic liquid. The downward passage of the meniscus was timed by a photoelectric device.

The passage of the meniscus in front of the upper lamp started the counter which had a quartz crystal oscillator. The counter stopped as the meniscus passed the lower lamp. The efflux time was registered and converted into a value of intrinsic viscosity through Huggins' equation (Huggins, M. L., J. Am. Chem. Soc., 1942, 64, 2716), using the flow time of the pure solvent at the same experimental conditions (same viscometer and same temperature). A single polymer solution was used to determine [η].

Polydispersity index: Determined at a temperature of 200 °C by using a parallel plates rheometer model RMS-800 marketed by RHEOMETRICS (USA), operating at an oscillation frequency which increases from 0.1 rad/see to 100 rad/sec. From the crossover modulus, the polydispersity index was determined using the equation:

P.I.=105/Gc
wherein Gc is the crossover modulus which is defined as the value (expressed in Pa) at which G′=G″,
wherein G′ is the storage modulus and G″ is the loss modulus.

### Ethylene (C2) Content

### ¹³C NMR of Propylene/Ethylene Copolymers

¹³C NMR spectra were acquired on a Bruker AV-600 spectrometer equipped with cryoprobe, operating at 160.91 MHz in the Fourier transform mode at 120 °C.

The peak of the Sββ carbon (nomenclature according to “Monomer Sequence Distribution in Ethylene-Propylene Rubber Measured by ¹³C NMR. 3. Use of Reaction Probability Mode” C. J. Carman, R. A. Harrington and C. E. Wilkes, Macromolecules, 1977, 10, 536) was used as internal standard at 29.9 ppm. The samples were dissolved in 1,1,2,2-tetrachloroethane-d2 at 120 °C with an 8% wt/v concentration. Each spectrum was acquired with a 90° pulse, 15 seconds of delay between pulses and CPD, thereby removing 1H-13C coupling. 512 transients were stored in 32K data points using a spectral window of 9000 Hz.

The assignments of the spectra, the evaluation of triad distribution and the composition were made according to Kakugo (“Carbon-13 NMR determination of monomer sequence distribution in ethylene-propylene copolymers prepared with δ-titanium trichloride-diethylaluminum chloride” M. Kakugo, Y. Naito, K. Mizunuma and T. Miyatake, Macromolecules, 1982, 15, 1150) using the following equations:

PPP=100T_{ββ}/S PPE=100T_{βδ}/S EPE=100T_{δδ}/S

PEP=100S_{ββ}/S PEE=100S_{βδ}/S EEE=100(0.25Sγδ+0.5S_{δδ})/S

S=T_{ββ}+T_{βδ}+T_{δδ}+S_{ββ}+S_{βδ}+0.25S_{γδ}+0.5S_{δδ}

The molar percentage of ethylene content was evaluated using the following equation:

E % mol=100*[PEP+PEE+EEE]

The weight percentage of ethylene content was evaluated using the following equation:

$$E \% wt . = \frac{100 * E \% mol * {MW}_{E}}{E \% mol * {MW}_{E +} P \% mol * {MW}_{P}}$$

where P % mol is the molar percentage of propylene content, while MWE and MWP are the molecular weights of ethylene and propylene, respectively.

The product of reactivity ratio r1r2 was calculated according to Carman (C. J. Carman, R. A. Harrington and C. E. Wilkes, Macromolecules, 1977; 10, 536) as:

$${r}_{1} {r}_{2} = 1 + ( \frac{EEE + PEE}{PEP} + 1 ) - ( \frac{P}{E} + 1 ) {( \frac{EEE + PEE}{PEP} + 1 )}^{0.5}$$

The tacticity of Propylene sequences was calculated as mm content from the ratio of the PPP mmTββ (28.90-29.65 ppm) and the whole Tββ (29.80-28.37 ppm).

### Samples for the Mechanical Tests

Samples have been obtained according to ISO 1873-2:2007.
Charpy impact test was determined according to ISO 179-1eA, and ISO 1873-2
Elongation at yield: measured according to ISO 527.
Elongation at break: measured according To ISO 527
Stress at break: measured according to ISO 527.
Tensile Modulus according to ISO 527-2,

### Melting Point and Crystallization Point

The melting point was measured by using a DSC instrument according to ISO 11357-3, at scanning rate of 20 °C/min both in cooling and heating, on a sample of weight between 5 and 7 mg, under inert N₂ flow. Instrument calibration made with Indium.

Determination of PP Inclusions in r-PE

¹³C NMR spectra were acquired on a Bruker AV-600 spectrometer equipped with cryoprobe, operating at 160.91 MHz in the Fourier transform mode at 120 °C.

The peak of the CH₂ ethylene was used as internal standard at 29.9 ppm. The samples were dissolved in 1,1,2,2-tetrachloroethane-d2 at 120 °C with an 8% wt/v concentration. Each spectrum was acquired with a 90° pulse, 15 seconds of delay between pulses and CPD, thereby removing 1H-13C coupling. 512 transients were stored in 32K data points using a spectral window of 9000 Hz. Molar composition was obtained according to the following using peak areas (Table A):

P=100 A₃/S

E=100 0.5A₂/S

Where S=0.5A₂+A₃

Molar content was transformed in weight using monomers molecular weight.

TABLE A
Assignment of PP/PE mixtures

| | Chemical Shift | | |
|---|---|---|---|
| Number | (ppm) | Carbon | Sequence |
| 1 | 48.8-45.4 | CH₂ | P |
| 2 | 29.9 | CH₂ | E |
| 3 | 29.0-28.0 | CH | P |
| 4 | 21.8-19.8 | CH₃ | P |

### EXAMPLES

### Example 1

In a plant operating continuously according to the mixed liquid-gas polymerization technique, the polymerization processes were carried out under the conditions specified in Table 1.

The polymerization was carried out in the presence of a catalyst system in a series of two reactors equipped with devices to transfer the product from the first reactor to the second reactor.

### Preparation of the Solid Catalyst Component

Into a 500 ml four-necked round flask, purged with nitrogen, 250 ml of TiCl₄ were introduced at 0 °C While stirring, 10.0 g of microspheroidal MgCl₂·1.9C₂H₅OH (prepared according to the method described in Example 2 of U.S. Pat. No. 4,399,054 but operating at 3000 rpm instead of 10000 rpm) and 9.1 mmol of diethyl 2,3-(diisopropyl) succinate were added. The temperature was raised to 100 °C and maintained for 120 min. Then, the stirring was discontinued. The solid product was allowed to settle. The supernatant liquid was siphoned off. Then 250 ml of fresh TiCl₄ were added. The mixture was reacted at 120 °C for 60 min. Then, the supernatant liquid was siphoned off. The solid was washed six times with anhydrous hexane (6×100 ml) at 60 °C

### Catalyst System and Prepolymerization Treatment

The solid catalyst component was contacted at 12 °C for 24 minutes with aluminum triethyl (TEAL) and dicyclopentyldimethoxysilane (DCPMS) as outside-electron-donor component. The weight ratio between TEAL and the solid catalyst component and the weight ratio between TEAL and DCPMS are specified in Table 1.

The catalyst system was then subjected to prepolymerization by suspending the catalyst system in liquid propylene at 20 °C for about 5 minutes before introducing the catalyst system into the first polymerization reactor.

### Polymerization Components a) and b)

The polymerization was carried out in continuous mode in a series of two reactors equipped with devices to transfer the product from the first reactor to the second reactor. The first reactor was a gas-phase polymerization reactor having two interconnected polymerization zones (riser and downer) as described in the European Patent No. 782587. The second reactor was a fluidized bed gas phase reactor. Polymer (a) was prepared in the first reactor, while polymer (b) was prepared in the second reactor. Temperature and pressure were maintained constant throughout the reaction. Hydrogen was used as molecular weight regulator.

The gas phase (propylene, ethylene and hydrogen) was continuously analyzed via gas-chromatography.

At the end of the polymerization process, the powder was discharged and dried under a nitrogen flow. The polymerization parameters are reported on Table 1.

TABLE 1
Polymerization Process

| | | Ex 1 | comp Ex 2 |
|---|---|---|---|
| Component A | | | |
| TEAL/external donor | wt/wt | 10 | 5 |
| TEAL/catalyst | wt/wt | 6 | 5 |
| Temperature | °C | 70 | 70 |
| Pressure | barg | 27 | 27 |
| H₂/C₃⁻ riser | mol/mol | 0.055 | 0.011 |
| Component B | | | |
| Temperature | °C | 75 | 75 |
| Pressure | barg | 14 | 1.8 |
| Split | % | 23 | 13.5 |
| C₂⁻/C₂⁻ + C₃⁻ | mol/mol | 0.350 | 0.35 |
| H2/C2— | mol/mol | 0.105 | 0.014 |

Then, the polymer particles of the heterophasic compositions of Example 1 and Comparative Example 2 were introduced into a twin screw extruder (Werner-type extruder), wherein the polymer particles were mixed with 10 wt % and 15 wt % (based on the total amount of polyolefins) of QCP5603 ivory (a r-PE commercially available from LyondellBasell, containing 10% wt of PP inclusions) and a stabilization package. The polymer particles were extruded under nitrogen atmosphere in a twin screw extruder, at a rotation speed of 250 rpm and a melt temperature of 200-250 °C.

TABLE 2
Characterization

| Example | 1 | comp ex 2 | 3 |
|---|---|---|---|
| component a) | | | |
| Homopolymer content, wt % | 61.6 | 78 | 57.7 |
| MFR, g/10 min | — | 2.0 | — |
| Polydispersity Index | 5.6 | 5.6 | 5.6 |
| Pentad content, molar % | >97 | >97 | >97 |
| Xylene soluble fraction, wt % | 1.5 | 1.5 | 1.5 |
| component b) | | | |
| Copolymer content, wt % | 18.4 | 12 | 17.3 |
| Ethylene content | 43.0 | 47 | 43.0 |
| (Calculated), wt. % | | | |
| Intrinsic viscosity [η] of the | 2.5 | 4.7 | 2.5 |
| xylene-soluble fraction, dl/g | | | |
| xylene-soluble fraction, wt % | 21.8 | | 21.8 |
| Ethylene content in the xylene | 37.4 | — | 37.4 |
| soluble fraction wt % | | | |
| melting point °C | 164.0 | 164.0 | 164.0 |
| MFR (a + b), g/10 min | 18.2 | | 18.2 |
| Polyethylene content, wt % | 10 | 10 | 15 |
| Density g/cm³ | 0.95 | 0.95 | 0.95 |
| Melt Index “E” g/10 min. | 0.3 | 0.3 | 0.3 |
| component d) wt % | 10 | 0 | 10 |
| MFR (d), g/10 min | 2.0 | — | 2.0 |
| density g/cm³ | 0.900 | — | 0.900 |

Properties of the final compositions are reported on Table 3.

TABLE 3
Properties of the final compositions

| Examples and comparative examples | | 1 | comp 2 | 3 |
|---|---|---|---|---|
| MFR, g/10 min | | 12.1 | 4.9 | 9.4 |
| Tensile Modulus, MPa | | 1240 | 1410 | 1170 |
| Charpy kJ/m² | at 23 °C | 12.7 | 11.1 | 14.3 |
| | at 0 °C | 7.6 | 7.2 | 8.5 |
| | at −20 °C | 5.8 | 5.5 | 6.2 |

What is claimed is:

1. A polypropylene composition comprising:
(a) from 45.7 wt % to 69.7 wt % of a crystalline propylene polymer, having an amount of isotactic pentads (mmmm), measured by 13C-MNR on the fraction insoluble in xylene at 25 °C,-higher than 97.0 molar % and a polydispersity index ranging from 3 to 15;
(b) from 5.3 wt % to 29.3 wt % of an elastomeric copolymer of ethylene and propylene, having an amount of recurring units deriving from ethylene, measured by ¹³C NMR ranging from 30.0 wt % to 70 wt %;
wherein, in the blend of components a) and b),
i) the polymer fraction soluble in xylene at 25 °C of components a)+b) ranging 10.0 wt % to 32.5 wt %;
ii) the polymer fraction soluble in xylene at 25 °C of components a)+b), having an intrinsic viscosity value, measured in tetrahydronaphthalene at 135 °C ranging from 1.5 dl/g to 2.8 dl/g;
iii) the ethylene derived units content, measured by ¹³C-NMR in the fraction soluble in xylene at 25 °C, of components a)+b ranging from 24.4 wt % to 43.5 wt %;
iv) the melting point, measured by DSC, of components a)+b ranging from 148.0 °C to 168.0 °C; and
v) the melt flow rate (ISO 1133-1 230 °C/2.16 kg) of components a)+b ranging from 10.0 to 30.0 g/10 min;
(c) from 3.0 wt % to 27.0 wt % of recycled polyethylene (r-PE), having a melt flow rate (ISO 1133-1 190 °C/2.16 Kg) from 0.1 to 10 g/10 min and containing an amount of polypropylene inclusions ranging from 1 wt % to 15 wt %, based upon the total r-PE component; and
d) from 1.0 wt % to 15.0 wt %, of a crystalline propylene homopolymer, having a melt flow rate (ISO 1133-1 230 °C/2.16 kg) ranging from 0.3 to 10.0 g/10 min; and a density (ISO 1183-1) ranging from 0.850 g/cm³ to 0.950 g/cm³;
wherein the whole composition having a value of melt flow rate (ISO 1133-1 230 °C/2.16 kg) ranging from 3.0 g/10 min to 21.0 g/10 min; and
the percentages of (a), (b), (c) and (d) being referred to the sum of (a), (b), (c) and (d).

2. The polypropylene composition according to claim 1, wherein:
component (a) ranges from 47.7 wt % to 67.7 wt %;
component (b) ranges from 7.3 wt % to 27.3 wt %;
component (c) ranges from 5.0 wt % to 25.0 wt %; and
component (d) ranges from 5.0 wt % to 13.0 wt %.

3. The polypropylene composition according to claim 2, wherein the polymer fraction soluble in xylene at 25 °C of components a)+b) ranges from 14.0 wt % to 28.2 wt %.

4. The polypropylene composition according to claim 1, having a melt flow rate (ISO 1133-1 230 °C/2.16 kg) ranges from 4.3 g/10 min to 18.0 g/10 min.

5. The polypropylene composition according to claim 1, wherein component (c) has an amount of PP inclusions ranging from 5 wt % to 10 wt % based on the total amount of component (c).

6. The polypropylene composition according to claim 1, wherein component (c) has a density (ISO 1183-1) ranging from 0.940 g/cm³ to 0.965 g/cm³ and a melt flow rate (ISO 1133-1 190 °C/2.16 Kg ISO 1133-1) ranging from 0.1 to 1.0 g/10 min.

7. The polypropylene composition according to claim 1, wherein the polymer fraction soluble in xylene at 25 °C of components a)+b) has an intrinsic viscosity value, measured in tetrahydronaphthalene at 135 °C, —ranging from 1.7 dl/g to 2.7 dl/g.

8. The polypropylene composition according to claim 1, wherein the ethylene derived units content, measured by ¹³C NMR in the fraction soluble in-xylene at 25 °C, of components a)+b) ranging from 31.0 wt % to 42.0 wt %.

9. The polypropylene composition according to claim 1, wherein component (b) has an amount of recurring units deriving from ethylene, measured by ¹³C NMR, ranging from 35.0 wt % to 60.0 wt-%.

10. The polypropylene-composition according to claim 1, wherein the intrinsic viscosity of the xylene soluble fraction at 25 °C of components a)+b), measured in tetrahydronaphthalene at 135 °C, ranges from 1.8-1.7 dl/g to 2.72.6 dl/g.

11. The polypropylene composition according to claim 1, wherein the melting point, measured by DSC, of components a)+b ranges from 154.0 °C to 167.0 °C.

12. The polypropylene-composition according to claim 1, wherein component d) has the melt flow rate (ISO 1133-1 230 °C/2.16 kg) ranging from 1.0 to 5.0 g/10 min.

13. The polypropylene composition according to claim 1, wherein component d) has a density (ISO 1183-1) ranging from 0.870 g/cm³ to 0.930 g/cm³.

14. An injection molded article comprising the polypropylene composition according to claim 1.

15. The injection molded article of claim 14, having the form of an automotive battery case.
